(19) United States
(12) Patent Application Publication
(10) Pub. No.: US 2017/0259862 A1
(43) Pub. Date: Sep. 14, 2017

(54) SIDE STAND FOR MOTORCYCLE

(71) Applicant: WAN-JYE CHENG, HSINCHU CITY (TW)

(72) Inventor: WAN-JYE CHENG, HSINCHU CITY (TW)

(21) Appl. No.: 15/098,763

(22) Filed: Apr. 14, 2016

(30) Foreign Application Priority Data
Mar. 11, 2016 (TW) 105107501

(51) Int. Cl. B62H 1/02

(52) U.S. Cl. CPC B62H 1/02

(57) ABSTRACT

An improved side stand for a motorcycle has a blocking board arranged on a motorcycle body. The electromagnetic fixing assembly has a metal rib with a top thereof having an oblique. An elastic supporting side stand is connected with the blocking board, joins the electromagnetic fixing assembly and is pressed by external force to rotate downward and move the electromagnetic fixing assembly. An inclined plane of the oblique leans against the blocking board to press the metal rib. When the oblique moves to the blocking board, the metal rib springs upward and pushes against the blocking board, whereby the elastic supporting side stand is fixed on the ground. When the motorcycle body starts, the metal rib retracts into the electromagnetic fixing assembly and the elastic supporting side stand springs upward. The metal rib retracted into the electromagnetic fixing assembly springs out of the electromagnetic fixing assembly after starting.

This application claims priority for Taiwan patent application no. 105107501 filed on Mar. 11, 2016, the content of which is incorporated in its entirely.

### BACKGROUND OF THE INVENTION

Field of the Invention

The present invention relates to a supporting side stand for parking a motorcycle, particularly to an improved side stand for a motorcycle controlling an elastic supporting side stand to spring by starting the motorcycle.

Description of the Related Art

A motorcycle or an electric motorcycle is provided with a side stand which is convenient for a user to park its motorcycle body. When the user does not have an enough room to press an H-shaped stand and park the motorcycle, the user can press down the side stand. After pressing down the side stand, the user can slowly push the motorcycle into a confined parking room. Besides, the side stand is pressed down more easily than the H-shaped stand. For weak users, the side stand has more convenience during the motorcycle body inclines until are supported by the ground. The utilization rate of the side stand is often higher than that of the H-shaped stand when the motorcycle is temporarily parked. As a result, the side stand is very important for the motorcycle design.

However, the relationship of the side stand supporting the motorcycle body should be more valued to avoid hurting the user and damaging the motorcycle body when the user uses the side stand. In the conventional technology, the side stand which has a shape of a rod with a fixed length is arranged below a left side of the motorcycle. Generally speaking, the side stand suits for the horizontal ground. The motorcycle is obliquely supported by the side stand. The side stand can support a center of gravity of the motorcycle on the ground. The user kicks and lift off the side stand to help the motorcycle move on before riding the motorcycle. The side stand is pressed down when parking the motorcycle. Nevertheless, the user easily forgets to retract the side stand due to his oversight. Thus, if the motorcycle moves on too fast, the side stand will touch the ground to easily cause overturn of the motorcycle whereby traffic accidents occur. The results of the traffic accidents range bruises to affection of life and damage to the motorcycle.

Accordingly, the inventor of the present invention disclosed a Taiwan Patent Application Number 104205213 which disclosed a safe motorcycle stand to overcome the abovementioned problems of the prior art. However, the patent connects an electromagnetic switch device with a motorcycle body to fasten a motorcycle stand whereby the stand is hard to be pressed down. Since the electromagnetic switch device is installed on the motorcycle body to correspond to the position of the motorcycle stand, the patent is hard to fabricate. Besides, since the position of the electromagnetic switch device is usually identical to that of a gasoline tank of the motorcycle, the position of the electromagnetic switch device should be adjusted. Preferably, the motorcycle body and the position of the electromagnetic switch device are designed at the same time. Thus, the electromagnetic switch device is not easily installed on the motorcycle that has been already designed. When the user wants to start the motorcycle or lift off the stand, insufficient or no start current has a limited effect in automatically retracting the stand from the ground. As a result, the inventor studies hard and then invents a better and different design.

To overcome the abovementioned problems, the present invention provides an improved side stand for a motorcycle to improve the side stand itself, thereby simplifying fabrication and avoiding installing an electromagnetic switch fixing a motorcycle stand and a motorcycle gasoline tank at the same position.

### SUMMARY OF THE INVENTION

A primary objective of the present invention is to provide an improved side stand for a motorcycle, which directly improves a side stand or a side foot stand of the motorcycle without installing additional switches on a motorcycle body to serve as a device controlling the side stand for the motorcycle, thereby avoiding affecting the design of the motorcycle body and reducing difficulty of installing the side stand on the motorcycle body. The improve side stand can be installed on a motorcycle that has been already designed or a new type of a motorcycle presented later on without affecting the design of its motorcycle body.

Another objective of the present invention is to provide an improved side stand for a motorcycle, which connects an elastic supporting side to stand with an electromagnetic fixing assembly, and which uses a metal rib thereof to fasten a blocking board whereby the elastic supporting side stand fixes a motorcycle body on the ground. After the motorcycle starts, the electromagnetic fixing assembly generates electromagnetic holding force to retract the metal rib into the electromagnetic fixing assembly whereby the elastic supporting side stand springs upward. Thus, a user can safely ride the motorcycle on a road.

To achieve the abovementioned objectives, the present invention provides an improved side stand for a motorcycle, which comprises a blocking board, an electromagnetic fixing assembly and an elastic supporting side stand. The blocking board is arranged below a side of a motorcycle body. For example, the blocking board is arranged below a left side of the motorcycle body. The electromagnetic fixing assembly is electrically connected with the motorcycle body. The electromagnetic fixing assembly has a metal rib with a top thereof having an oblique protruded from the electromagnetic fixing assembly. The elastic supporting side stand is connected with the blocking board, joins the electromagnetic fixing assembly and is pressed by external force to rotate downward and move the electromagnetic fixing assembly. An inclined plane of the oblique of the metal rib leans against the blocking board to press downward the metal rib. When the oblique moves to the blocking board, the metal rib springs upward and uses a vertical plane of the oblique to push against the blocking board, whereby the elastic supporting side stand is fixed at a side of the motorcycle body and on the ground. When the motorcycle body starts, the electromagnetic fixing assembly generates electromagnetic holding force to immediately retract the metal rib into the electromagnetic fixing assembly and separate the metal rib from the blocking board, and the elastic supporting side stand springs upward. After starting the motorcycle body, the metal rib retracted into the electromagnetic fixing assembly springs out of the electromagnetic fixing assembly.

The elastic supporting side stand further comprises a supporting stand and an elastomer. The supporting stand is fixedly connected with the blocking board and joins the electromagnetic fixing assembly. The elastomer is arranged on the supporting stand and at a side of the supporting stand, and the supporting stand rotates whereby the elastomer generates elastic force.

The supporting stand joins the electromagnetic fixing assembly by welding whereby the electromagnetic fixing assembly is arranged at a side of the elastic supporting side stand. Alternatively, the supporting stand further has an accommodation space, and the supporting stand connects the electromagnetic fixing assembly to the accommodation space.

The electromagnetic fixing assembly further comprises a manual switch arranged on the electromagnetic fixing assembly and fastening the metal rib, and the manual switch pushes the metal rib into the electromagnetic fixing assembly whereby the elastic supporting side stand springs upward. When the motorcycle starts not to efficiently retract the metal rib into the electromagnetic fixing assembly, a user himself can manually retract the elastic supporting side stand. Besides, the electromagnetic fixing assembly is further provided with a locking portion arranged at a side of the manual switch and locking the manual switch and the locking portion by a locking member, thereby avoiding turning on the manual switch intentionally or accidently.

The metal rib is further provided with at least one groove, and the electromagnetic fixing assembly is further provided with a hole. The groove penetrates downward from a surface of the oblique, so as to reduce weight of the metal rib and friction among the metal rib, a bottom seat and a connecting case. When external objects, such as fine sand, enter into the least one groove, the external objects flow out of the hole.

Below, the embodiments are described in detail in cooperation with the drawings to make easily understood the technical contents, characteristics and accomplishments of the present invention.

### BRIEF DESCRIPTION OF THE DRAWINGS

FIG. 1 is a diagram schematically showing an improved side stand for a motorcycle arranged on a motorcycle body according to an embodiment of the present invention;

FIG. 2 is a perspective view showing an improved side stand for a motorcycle connected with a vertical supporting stand according to an embodiment of the present invention;

FIG. 3 is a cross-sectional view showing an electromagnetic fixing assembly according to an embodiment of the present invention;

FIG. 4 is a diagram schematically showing an improved side stand for a motorcycle when not in use according to an embodiment of the present invention;

FIG. 5 is a diagram schematically showing a metal rib of an improved side stand for a motorcycle pressed by a blocking board according to an embodiment of the present invention;

FIG. 6 is a diagram schematically showing an improved side stand for a motorcycle when in use according to an embodiment of the present invention; and

FIG. 7 is a diagram schematically showing operation of a locking portion and a manual switch in an improved side stand for a motorcycle according to an embodiment of the present invention.

### DETAILED DESCRIPTION OF THE INVENTION

Nowadays, a side foot stand, an oblique foot stand or a side stand at a side of a motorcycle body is usually used to park its motorcycle. The present invention discloses an improved side stand for a motorcycle arranged a side of a motorcycle body to reduce danger due to a fact that a user forgets to retract the side stand while riding the motorcycle and to improve skid-proof properties when parking the motorcycle.

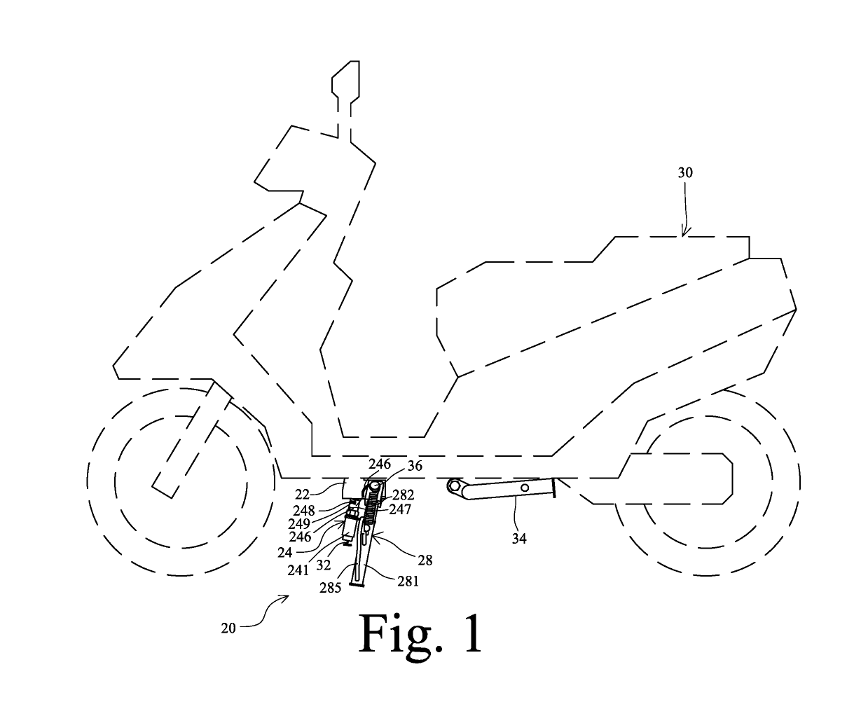

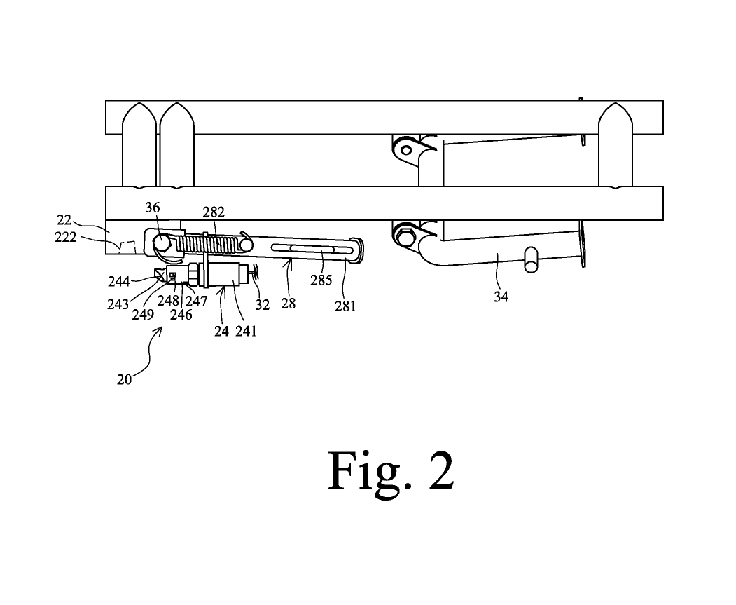

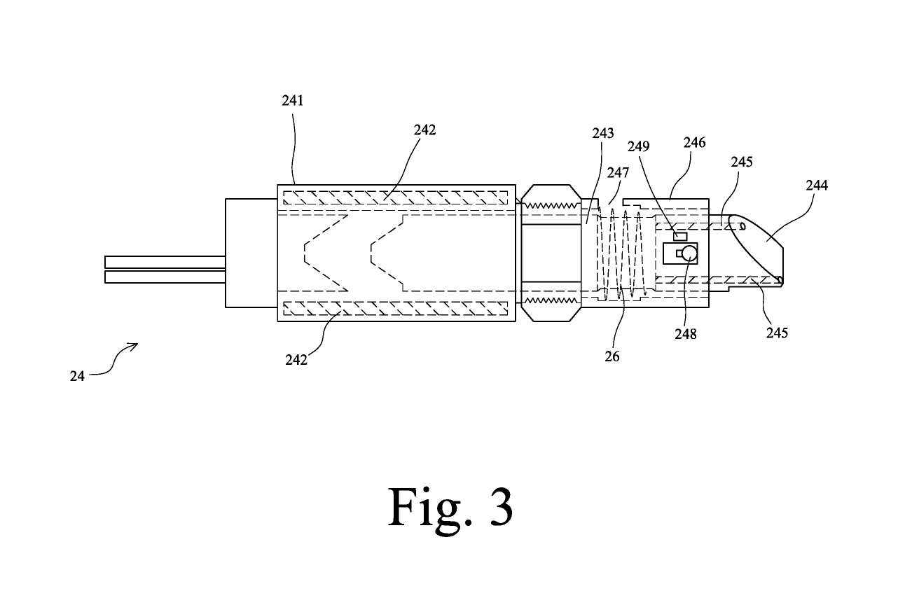

Refer to FIG. 1, FIG. 2 and FIG. 3. An improved side stand 20 for a motorcycle comprises a blocking board 22, an electromagnetic fixing assembly 24, a spring 26 and an elastic supporting side stand 28. The blocking board 22 is arranged below a side of a motorcycle body 30 and has a join portion 222. In the embodiment, the join portion 222 is a recess having a shape of a quadrilateral, but the present invention is not limited thereto. The electromagnetic fixing assembly 24 is electrically connected with the motorcycle body 30. In the embodiment, the electromagnetic fixing assembly 24 is electrically connected with the motorcycle body 30 through a signal line 32. The signal line 32 is arranged on a bottom of the electromagnetic fixing assembly 24. The embodiment does not limit the connection way and position of the signal line 32. The electromagnetic fixing assembly 24 further comprises a bottom seat 241 with a trough wall therein annually provided with an electromagnetic coil set 242. The bottom seat 241 joins a metal rib 243 with a bottom joining the bottom of the bottom seat 241. A top of the metal rib 243 has an oblique 244 protruded from the bottom seat 241. The metal rib 243 is further provided with at least one groove 245. The embodiment exemplifies two grooves 245. The two grooves 245 penetrate downward from a surface of the oblique 244. A connecting case 246 joins the bottom seat 241 and is provided with a hole 247. In the embodiment, the bottom seat 241 screws into the connecting case 246 whereby the bottom seat 241 joins the connecting case 246. The connecting case 246 accommodates a part of the metal rib 243 protruded out of the bottom seat 241 and the oblique 244 emerges from the connecting case 246. The connecting case 246 is provided with a manual switch 248 fastening the metal rib 243. The electromagnetic fixing assembly 24 is further provided with a locking portion 249 arranged on the connecting case 246 and at a side of the manual switch 248. A spring 26 is annularly arranged on the part of the metal rib 243 protruded out of the bottom seat 241 and arranged in the connecting case 246. The elastic supporting side stand 28 is connected with the blocking board 22 and joins the electromagnetic fixing assembly 24. In the embodiment, the elastic supporting side stand 28 further comprises a supporting stand 281 and an elastomer 282. The supporting stand 281 is fixedly connected with the blocking board 22. In the embodiment, the supporting stand 281 joins the electromagnetic fixing assembly 24 by welding, whereby the electromagnetic fixing assembly 24 fixes a side of the supporting stand 281 by welding. The supporting stand 281 is screwed to the blocking board 22 using a screw 36. A bottom of the supporting stand 281 is provided with a tread portion 285. The elastomer 282 is arranged on the supporting stand 281 and at a side of the supporting stand 281. Besides, the motorcycle body 30 is provided with a vertical supporting stand 34 therein. The vertical supporting stand 34 is arranged below the motorcycle body 30 and connected with the blocking board 22 whereby the vertical supporting stand 34 and the blocking board 22 are integrally formed as a piece. The vertical supporting stand 34 is a metal stand.

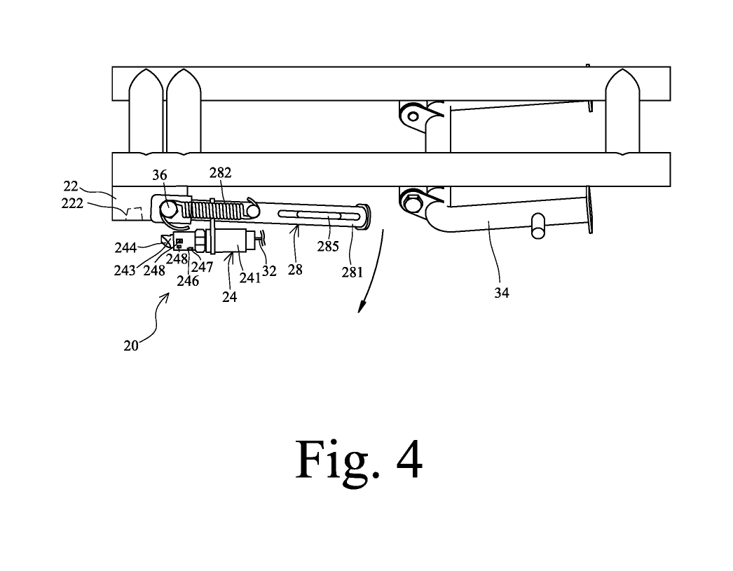

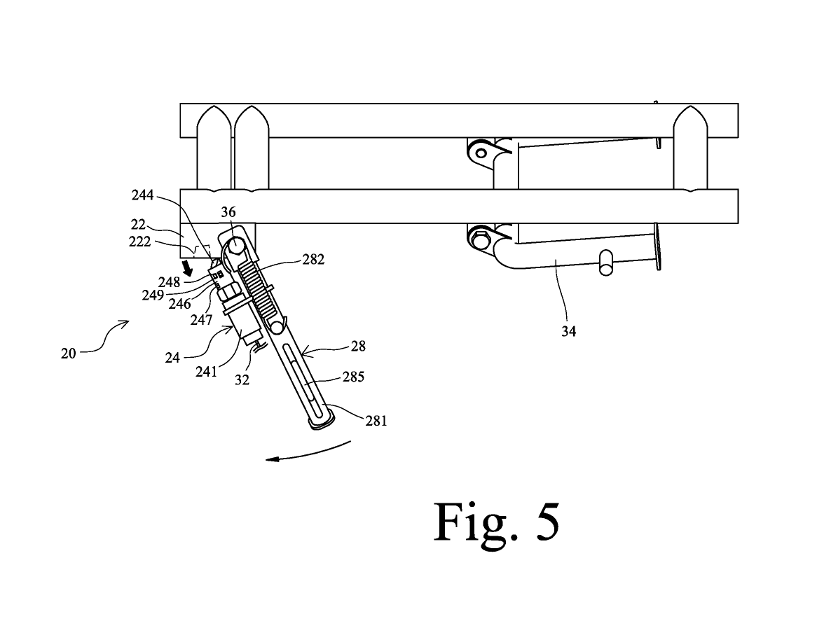

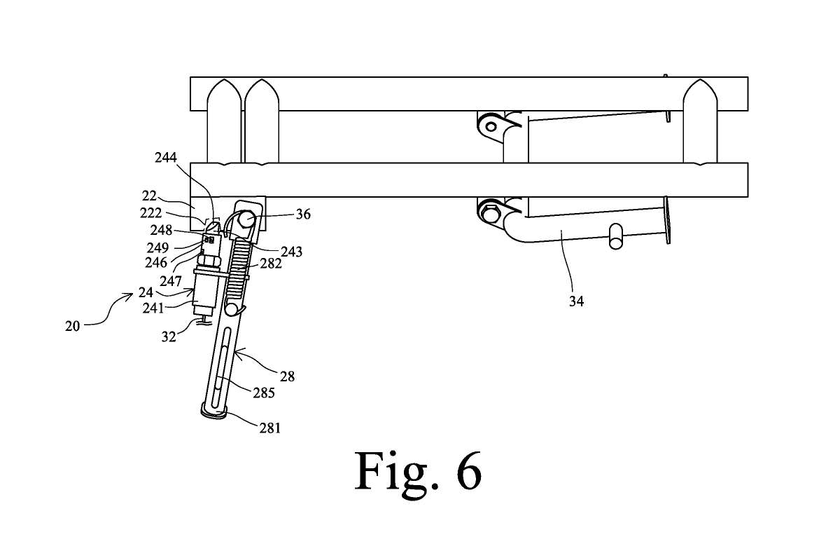

After describing the positions of the elements of the present invention, refer to FIG. 4, FIG. 5 and FIG. 6 to explain use of the present invention in detail. Firstly, refer to FIG. 4, FIG. 1 and FIG. 3. When the improved side stand 20 for the motorcycle is not in use, the elastic supporting side stand 28 is parallel to the ground and retracted without touching the ground. When a user wants to park the motorcycle, the user uses his foot to tread the elastic supporting side stand 28. Then, the user applies external force to the tread portion 285 arranged on the supporting stand 281 so that the elastic supporting side stand 28 is pressed by the external force to rotate downward and move the electromagnetic fixing assembly 24, as shown in FIG. 5. Meanwhile, an inclined plane of the oblique 244 of the metal rib 243 leans against the blocking board 22 to press downward the metal rib 243 and the spring 26. The elastomer 282 of the elastic supporting side stand 28 is also pressed by rotating the supporting stand 281 of the elastic supporting side stand 28. Refer to FIG. 6, FIG. 1 and FIG. 3. After the oblique 244 of the metal rib 243 slides through the blocking board 22, the oblique 244 is disposed under the join portion 222 of the blocking board 22. There is a joinable space over the metal rib 243 whereby the metal rib 243 is not pressed. The joinable space is the join portion 222 of the blocking board 22 accommodating the metal rib 243. The spring 26 springs upward to push the metal rib 243 whereby the metal rib 243 and the oblique 244 join the join portion 222. A vertical surface of the oblique 244 pushes against a trough wall of the join portion 222. The oblique 244 of the metal rib 243 is used to fasten the join portion 222 to fix the position of the electromagnetic fixing assembly 24 whereby the elastic supporting side stand 28 is fixed at a side of the motorcycle body 30 and on the ground. Then, before the user rides the motorcycle, the user turns on a start switch of the motorcycle body 30. When the start switch is turned on, a start current is immediately generated and transmitted to the electromagnetic fixing assembly 24 through the signal line 32. The start current flows through the electromagnetic coil set 242 arranged on the bottom seat 241 to generate electromagnetic holding force, so as to immediately retract the metal rib 243 into the bottom seat 241 and separate the vertical surface of the oblique 244 of the metal rib 243 from the join portion 222. Simultaneously, the elastomer 282 generates elastic force whereby the elastic supporting side stand 28 springs upward from the ground since the elastomer 282 is pressed. The metal rib 243 immediately retracted into the bottom seat 241 springs out of the bottom seat 241 after the start current disappears. At this time, the electromagnetic fixing assembly 24 and the elastic supporting side stand 28 of the improved side stand for the motorcycle are retracted and parallel to the ground, as shown in FIG. 4.

Furthermore, refer to FIG. 1, FIG. 2 and FIG. 3. The start current of the motorcycle body 30 can drive the electromagnetic fixing assembly 24 whereby the metal rib 243 is retracted into the bottom seat 241. If the user starts the motorcycle whereby the electromagnetic fixing assembly 24 is not efficiently driven, the metal rib 243 remains its original state so that the elastic supporting side stand 28 still touches the ground, which results in inconvenience during the user rides the motorcycle. At this time, the user can manually control the manual switch 248. For example, the user presses the manual switch 248 whereby the metal rib 243 is retracted into the bottom seat 241 and the elastic supporting side stand 28 springs upward. Then, the user rides the motorcycle so that it moves on. In addition, the inconvenience reminds the user of determining whether there are problems with the signal line 32 and lines of the motorcycle body 30, or determining whether there is a problem with the insufficient start current inputting the start switch of the motorcycle body 30.

Refer to FIG. 1 and FIG. 2. The vertical supporting stand 34 is an H-shaped stand or also called a main supporting stand, whose use is the same to that of the conventional technology. The user uses its foot to press the vertical supporting stand 34 whereby the vertical supporting stand 34 supports the motorcycle body 30 on the ground. In practice, the blocking board 22 of the improved side stand 20 for the motorcycle and the vertical supporting stand 34 can separate with each other or be integrally formed as a piece without affecting their operation. As a result, the blocking board 22 and the vertical supporting stand 34 are integrally fabricated as a metal piece or are separately fabricated without affecting their fabrication. Accordingly, the present invention applies to a new type of the motorcycle body or the motorcycle body that has to been already designed and massively produced and that is excellently used. The present invention cooperates with a new type of the motorcycle body to be integrally formed as a piece, or is directly installed on the existing side stand for the motorcycle by welding, lest the user forget to retract the side stand when riding the motorcycle.

Then, refer to FIG. 3. The grooves 245 penetrating downward from the surface of the oblique 244 and the hole 247 of the connecting case 246 are used to release unnecessary external objects such as fine blockages, lest the metal rib 243 easily jam when moving. For example, when the motorcycle is parked outside, fine blockages such as fine sand flow into joins among the connecting case 246, the bottom seat 241 and the metal rib 243 of the electromagnetic fixing assembly 24. The grooves 245 and the hole 247 are used to easily release the fine blockages from the grooves 245, so as to reduce friction among the metal rib 243, the bottom seat 241 and the connecting case 246. Besides, the hollow groove 245 can decrease the whole weight of the metal rib 243 and the motorcycle, and fuel consumption.

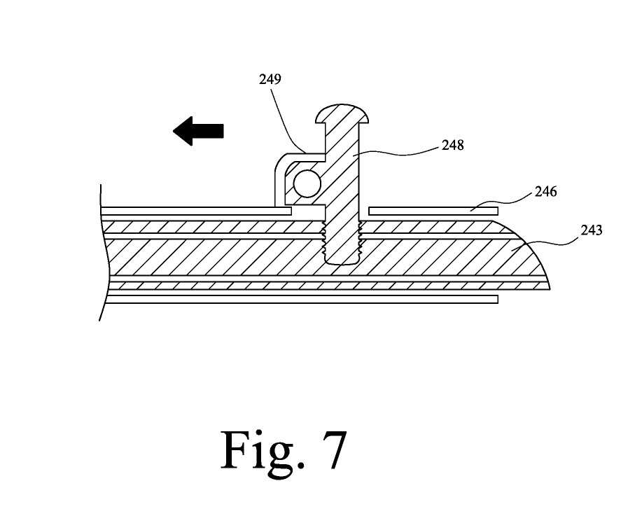

When the motorcycle starts, the elastic supporting side stand of the present invention can automatically spring using the electromagnetic fixing assembly. The present invention avoids forgetting to tread whereby traffic accidents occur when the user rides the motorcycle, and avoids using the improved side stand for the motorcycle to touch the ground whereby the motorcycle easily get out of control when driving. The present invention can completely avoid these accidents. Moreover, if the motorcycle starts not to automatically retract the improved side stand for the motorcycle, the manual switch can control the elastic supporting side stand to spring upward lest the motorcycle be hard to move on when the user rides the motorcycle. Refer to FIG. 7 and FIG. 1. The present invention does not limit the design of the manual switch 248. The manual switch 248 is additionally provided with a locking design. For example, when a locking hole of the manual switch 248 is aligned with a locking hole of the locking portion 249, an external lock such as a U-shaped lock passes through the two locking holes to lock them. This has an advantage that the manual switch 248 is not pushed downward before unlocking. As a result, the others cannot easily retract the improved side stand 20 for the motorcycle of the user, and then lead away the motorcycle body 30. Alternatively, the others cannot illegally start the motorcycle and leave with the motorcycle. Additionally, the size of the lock locking the manual switch 248 and the locking portion 249 is far less than that of a big lock locking a motorcycle, so as to save the weight and cost of the lock of the user. In addition, the present invention uses the metal rib of the electromagnetic fixing assembly to join the join portion of the blocking board. Alternatively, without the join portion, the present invention also uses the metal rib to slide through the blocking board, and uses the vertical plane of the oblique of the metal rib to push against the blocking board whereby the supporting position is fixed and deadlocked when the elastic supporting side stand supports the motorcycle body on the ground. When the user parks the motorcycle on an ascent, the present invention can enhance the stability of parking the motorcycle on the ascent. In such a case, when the others touch or push the motorcycle on the ascent, the side stand for the motorcycle does not easily spring whereby the motorcycle loses support and falls down.

The main spirit of the present invention is directly to improve the side stand for the motorcycle, and thus provides an improved side stand for a motorcycle without installing additional switches on the existing motorcycle body to serve as a device controlling the side stand for the motorcycle. As a result, in the abovementioned embodiment, the bottom seat and the connecting case of the electromagnetic fixing assembly are screwed to join them, which is convenient for the user to disassemble the electromagnetic fixing assembly and replace internal elements thereof such as springs with elastic fatigue, and which is helpful in maintaining the internal elements and cleaning soil. The present invention does not limit the connection way. In addition to joining the electromagnetic fixing assembly and the supporting stand by welding, they are fixed by screws. Alternatively, the supporting stand is hollowed out whereby the supporting stand further has an accommodation space. Then, the electromagnetic fixing assembly connects to the accommodation space of the supporting stand. This connection way is described as the abovementioned paragraph, so will not be reiterated. The present invention directly improves the side stand for the motorcycle to avoid affecting the design of the motorcycle body. Even if the present invention applies to a new type of the motorcycle body later on, the fabrication of the present invention is very simple, thereby greatly reducing difficulty of installing the improved side stand for the motorcycle on the motorcycle body.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An improved side stand for a motorcycle comprising:
a blocking board arranged below a side of a motorcycle body;
an electromagnetic fixing assembly electrically connected with said motorcycle body, and said electromagnetic fixing assembly has a metal rib with a top thereof having an oblique protruded from said electromagnetic fixing assembly; and
an elastic supporting side stand connected with said blocking board, joining said electromagnetic fixing assembly and pressed by external to force to rotate downward and move said electromagnetic fixing assembly, and an inclined plane of said oblique of said metal rib leans against said blocking board to press downward said metal rib, and when said oblique moves to said blocking board, said metal rib springs upward and uses a vertical plane of said oblique to push against said blocking board, whereby said elastic supporting side stand is fixed at a side of said motorcycle body and on a ground, and when said motorcycle body starts, said electromagnetic fixing assembly generates electromagnetic holding force to immediately retract said metal rib into said electromagnetic fixing assembly and separate said metal rib from said blocking board, and said elastic supporting side stand springs upward, and after starting said motorcycle body, said metal rib retracted into said electromagnetic fixing assembly springs out of said electromagnetic fixing assembly.

2. The improved side stand for the motorcycle of claim 1, wherein said elastic supporting side stand further comprises:
a supporting stand fixedly connected with said blocking board and joining said electromagnetic fixing assembly; and
an elastomer arranged on said supporting stand and at a side of said supporting stand, and said supporting stand rotates whereby said elastomer generates elastic force.

3. The improved side stand for the motorcycle of claim 2, wherein said supporting stand joins said electromagnetic fixing assembly by welding whereby said electromagnetic fixing assembly is arranged at a side of said elastic supporting side stand.

4. The improved side stand for the motorcycle of claim 2, wherein said supporting stand further has an accommodation space, and said supporting stand connects said electromagnetic fixing assembly to said accommodation space.

5. The improved side stand for the motorcycle of claim 1, wherein said electromagnetic fixing assembly further comprises a manual switch arranged on said electromagnetic fixing assembly and fastening said metal rib, and said manual switch pushes said metal rib into said electromagnetic fixing assembly whereby said elastic supporting side stand springs upward.

6. The improved side stand for the motorcycle of claim 5, wherein said electromagnetic fixing assembly is further provided with a locking portion arranged at a side of said manual switch and locking said manual switch and said locking portion by a locking member.

7. The improved side stand for the motorcycle of claim 1, wherein said metal rib is further provided with at least one groove, and said electromagnetic fixing assembly is further provided with a hole, said at least one groove penetrates downward from a surface of said oblique, and when external objects enter into said least one groove, said external objects flow out of said hole.

8. The improved side stand for the motorcycle of claim 1, wherein said electromagnetic fixing assembly is electrically connected with said motorcycle body, and said electromagnetic fixing assembly further comprises:
a bottom seat with a trough wall therein annularly provided with an electromagnetic coil set, and said bottom seat joins said metal rib, and said oblique of said metal rib is protruded out of said bottom seat;
a connecting case joining said bottom seat and accommodating a part of said metal rib protruded out of said bottom seat and said oblique emerges from said connecting case; and
a spring annularly arranged on said part of said metal rib protruded out of said bottom seat and arranged in said connecting case, and when said metal rib is pressed by said blocking board, said metal rib presses said spring, and when metal rib is not pressed, said spring springs upward and pushes said metal rib.

9. The improved side stand for the motorcycle of claim 8, wherein when said motorcycle body starts, said motorcycle body transmits a start current to said bottom seat of said electromagnetic fixing assembly whereby said electromagnetic coil set generates said electromagnetic holding force.

10. The improved side stand for the motorcycle of claim 8, wherein said blocking board further has a join portion accommodating said oblique of said metal rib whereby said vertical plane of said oblique pushes against said join portion.
